(19) United States
(12) Patent Application Publication
(10) Pub. No.: US 2007/0080596 A1
(43) Pub. Date: Apr. 12, 2007

(54) MAGNETIC MOTOR

(75) Inventor: Victor Diduck, Kelowna, British Columbia (CA)

Correspondence Address: VERMETTE & CO., SUITE 320 - 1177 WEST HASTINGS STREET, VANCOUVER, BC, V6E2K3, CA

(73) Assignee: S.L PROMOTIONS CORPORATION, Kelowna, British Columbia (CA)

(21) Appl. No.: 11/163,273

(22) Filed: Oct. 12, 2005

(51) Int. Cl. H02K 16/02; H02K 21/00

(52) U.S. Cl. 310/152; 310/114; 310/156.47

(57) ABSTRACT

A frame having a shaft coupled thereto and a pair of non-magnetic wheels mounted on the shaft. Either the wheels are rotatable on the shaft or the shaft itself is rotatable. Each wheel has a plurality of equally spaced apart grooves running over a cylindrical surface of the wheel from a first side to a second side of the wheel. The radial separation of a start of the groove on the first side to an end of the groove on the second side is 40 degrees. An orientation of the grooves on one of the wheels of the pair of wheels is opposite to that of the other wheel. A pair of non-magnetic cowlings each have a semi-circular surface facing the wheel of slightly larger diameter than the wheel. A pair of spaced apart permanent magnets are affixed to an outside surface of each of the pair of cowlings and are oriented with a north pole of each of the permanent magnets facing a corresponding cowling. The permanent magnets on the front cowling are ⅛^{th} and ⅝^{th} up, respectively, from a bottom thereof and the permanent magnets on the rear cowling are ⅜ths and 15/16^{th} up from a bottom thereof. A plurality of permanent magnets are placed in the grooves in a pattern with two permanent magnets placed on opposite sides of each of two adjacent grooves and one placed at the center of a third groove adjacent to the two adjacent grooves. Permanent magnets for subsequent grooves are placed with the same pattern. A north pole of each of the permanent magnets faces outwardly.

### FIELD

The present invention relates to a magnetic motor that rotates without the need for external energy input such as fuel.

### BACKGROUND

There have been a number of magnetic motors developed such as that in U.S. Pat. No. 4,151,431 issued to Howard Johnson. In most such devices no working models have been achieved. In order to make a permanent magnet motor operate it is necessary to accomplish a switching function equivalent to that accomplished in electric motors by brushes, commutators, alternating current, or other means. In permanent magnet motors this means that magnetic leakage must be shielded so as to reduce it as a loss factor. A proper combination of materials, geometry and magnetic concentration are required in order to be able to construct a motor that can operate continuously made with permanent magnets.

### SUMMARY OF THE INVENTION

According to the invention there is provided a frame; a shaft coupled to the frame and a pair of non-magnetic wheels mounted on the shaft. Either the wheels are rotatable on the shaft or the shaft itself is rotatable. Each wheel has a plurality of equally spaced apart grooves running over a cylindrical surface of said wheel from a first side to a second side of the wheel. The radial separation of a start of the groove on the first side to an end of the groove on the second side is 40 degrees. An orientation of the grooves on one of the wheels of the pair of wheels is opposite to that of the other wheel. A pair of non-magnetic cowlings each have a semi-circular surface facing the wheel of slightly larger diameter than the wheel. A pair of spaced apart permanent magnets are affixed to an outside surface of each of the pair of cowlings and are oriented with a north pole of each of said permanent magnets facing a corresponding cowling. The permanent magnets on the front cowling are ⅛^{th} and ⅝^{th} up, respectively, from a bottom thereof and the permanent magnets on the rear cowling are ⅜ths and 15/16^{th} up from a bottom thereof. A plurality of permanent magnets are placed in the grooves in a pattern with two permanent magnets placed on opposite sides of each of two adjacent grooves and one placed at the center of a third groove adjacent to the two adjacent grooves. Permanent magnets for subsequent grooves are placed with the same pattern. A north pole of each of the permanent magnets faces outwardly.

The number of grooves on each wheel may be an integral multiple of 9.

A pair of the cowlings associated with one of the wheels are adjustably movable towards or away from the one wheel so as to adjust the spacing between the one wheel and each cowling of the pair of cowlings.

The grooves on a left side wheel of the pair of wheels may be inclined upwardly from left to right at an acute angle and those on a right side wheel of the pair of wheels may be inclined downwardly from left to right at an acute angle.

Preferably, the cowlings each have holes to threadedly receive ferromagnetic bolts to assist in eliminating dead spots.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a perspective view of the magnetic motor;

FIG. 2 is partially disassembled perspective view of the magnetic motor;

FIG. 3 is another view of the partially disassembled motor of FIG. 2;

FIG. 4 is a schematic diagram of the right front cowling showing the position of bolts and permanent magnets;

FIG. 5 is a schematic diagram of the left front cowling showing the position of bolts and permanent magnets;

FIG. 6 is a schematic diagram of the right rear cowling showing the position of bolts and permanent magnets;

FIG. 7 is a schematic diagram of the left rear cowling showing the position of bolts and permanent magnets;

FIG. 8 is a front elevation view of a wheel template used to mark the positions of grooves or channels in the wheel;

FIG. 9 is a side view of the grooved wheel and the wheel template used to mark the grooved wheel during fabrication;

FIG. 10 is a front elevation view of right grooved wheel showing the permanent magnet placement; and

FIG. 11 is a front elevation view of left grooved wheel showing the permanent magnet placement.

### DETAILED DESCRIPTION WITH REFERENCE TO THE DRAWINGS

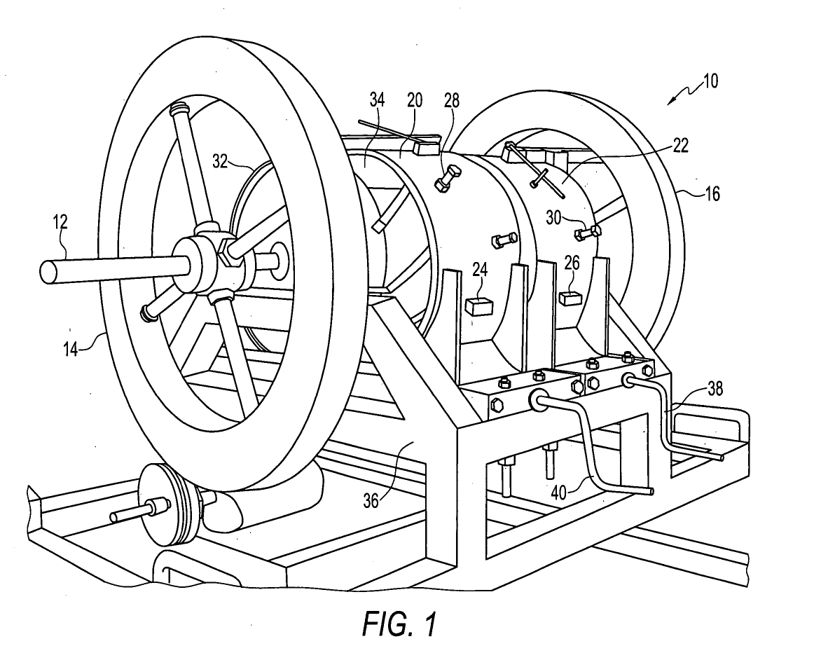

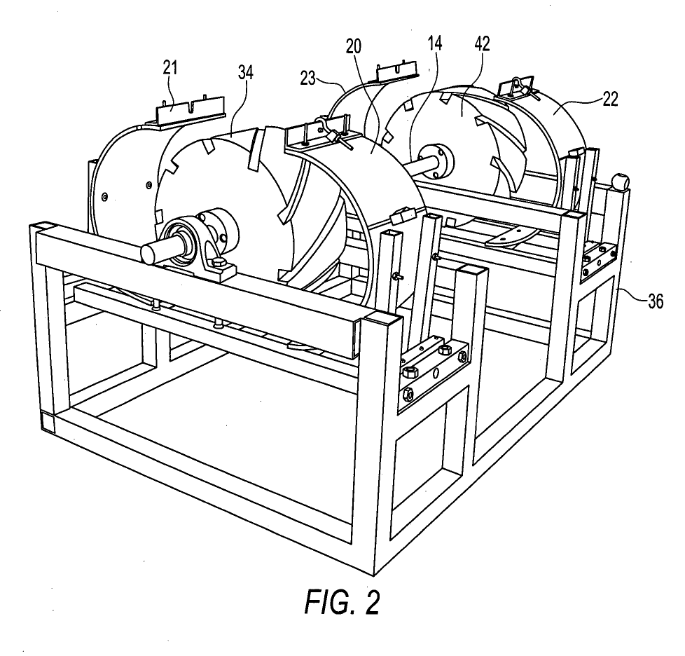

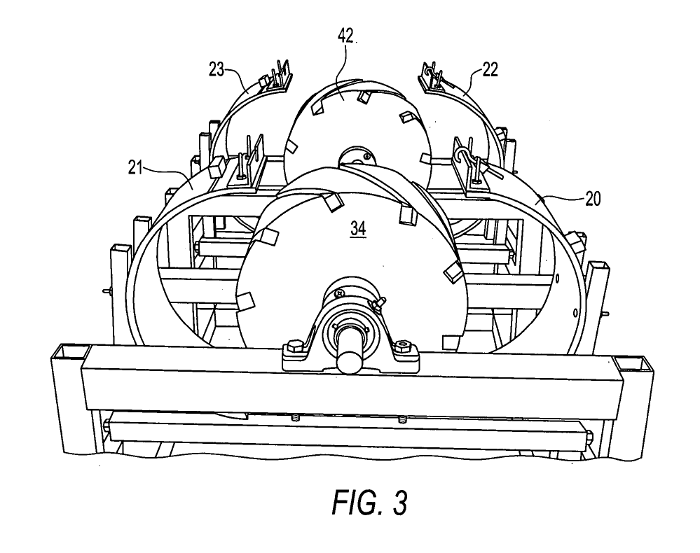

Referring to FIGS. 1, 2, and 3 the magnetic motor 10 is made up of two solid non-magnetic wheels 34 and 42 (see FIG. 2) mounted on a shaft 14. Each wheel 34 and 42 has a plurality of grooves running from one side to the other at an angle of about 20 degrees to the shaft 12 with the grooves on one wheel running at an angle opposite to those on the other wheel. Around each wheel 34 and 42 are a respective pair of cowlings 20, 32 and 22, 23 of the same curvature as the wheels 34 and 42 with each cowling covering slightly less than ½ the wheel. Cranks 40 and 38 adjust each pair of cowlings 20, 32 and 22, 23 by moving them towards or away from each other and the associated wheels 34 and 42. A pair of flywheels 14 and 16 are mounted on each end of the shaft 12. Shaft 12 is rotatably mounted on a frame 36.

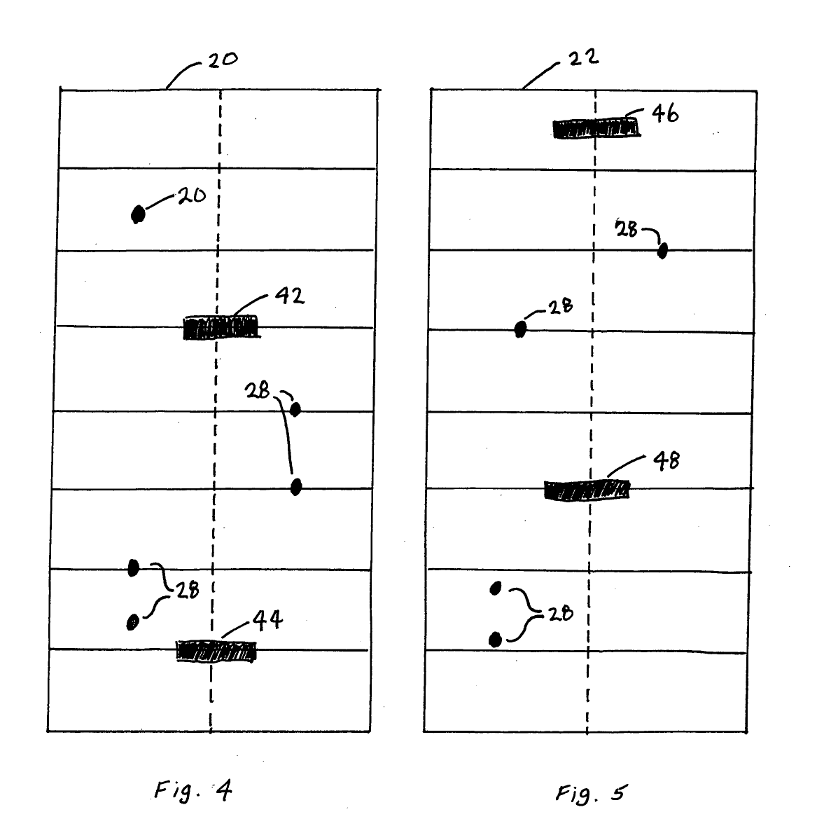

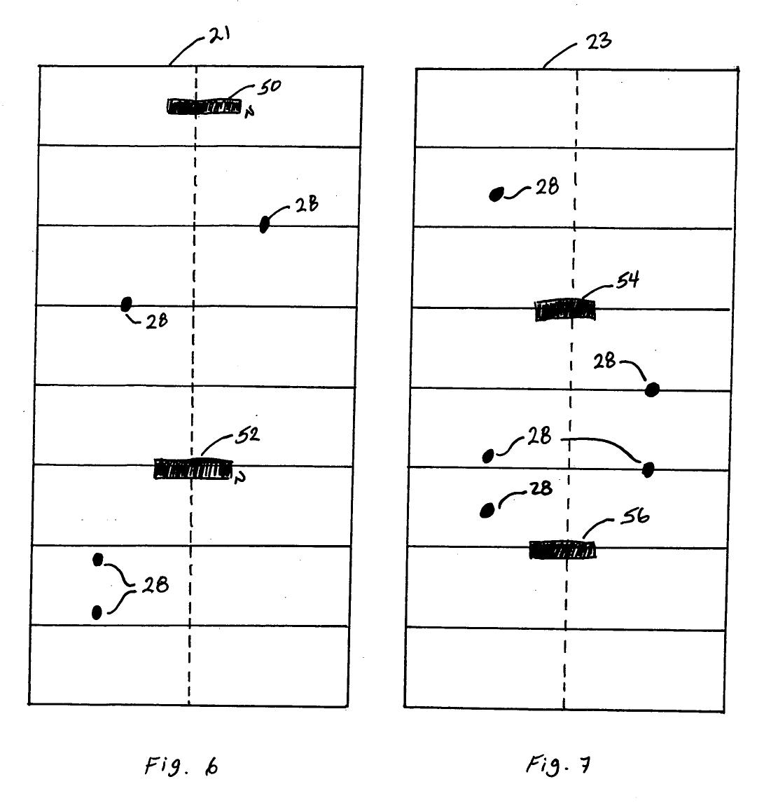

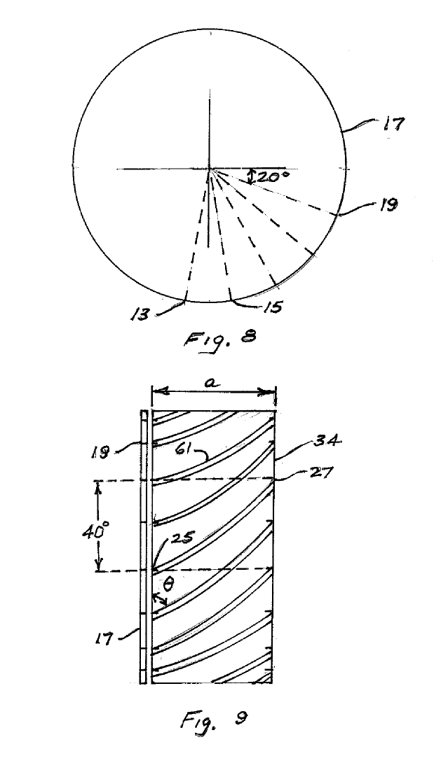

Referring to FIG. 4 which is a schematic diagram of the outside front surface of the cowling in flat form, two permanent magnets 42 and 44 are glued to the outside surface with the north pole adjacent to the cowling and the south pole facing away from the cowling, along the line bisecting the center and disposed horizontally. The first magnet 44 is positioned ⅛ the way up from the bottom and the second 42 positioned 5/8 the way up from the bottom. Bolts 28 are inserted as shown in order to modify the magnetic field to eliminate dead spots. Similarly, as seen in FIG. 5 permanent magnets are placed ⅜^{th} the way up and 15/26^{th} the way up along the center, with the bar magnets horizontal.

The right rear cowling 21 is shown in FIG. 6. In this case the magnet and bolt placement is the same as that for the left front cowling 22. The left rear cowling 23 has permanent magnets 56 and 54 ¼ the way up and ⅝^{th} the way up. The bolt placements are as in FIG. 4 except for the bottom two which are higher.

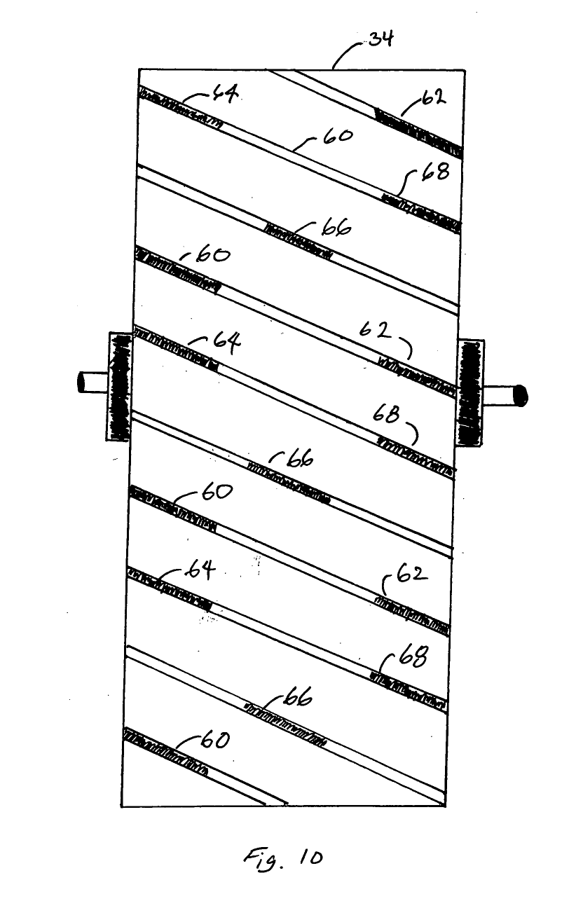

Referring to FIG. 8, a wheel template 17 is in the form of a disk having a plurality of regularly spaced apart markings on the periphery with each marking angularly spaced 20 degrees away from adjacent markings. Mark 15 corresponds to the distance of closest approach by each of the cowlings 20 and 22 to corresponding ones of wheels 34 and 42, respectively. Mark 13 corresponds to the distance of closest approach by each of cowlings 21 and 23 to wheels 34 and 42. The angle from the vertical of each of marks 13 and 15 is 10 degrees. Markings of 20 degrees are made on the periphery of disk 17 measured from marks 13 and 15. The radius of the disk corresponds to the radius of the wheels 34 and 42. These markings are transferred to each side of each wheel 34 and 42 as shown in FIG. 9. Grooves 61 are machined in the cylindrical surface of each wheel 34 and 42 commencing from one mark and terminating in two marks away on the opposite side of the wheel 34 and 42 corresponding to a 40 degree change from the starting point as measured by the wheel template 17. Similar marks are joined by parallel grooves 61. For a wheel 34 with the width “a” equal to 5 inches, the incline of the grooves relative to a line parallel to the axis of the wheel 34 is 35 degrees. If the width “a” were to increase the change over the length of a groove would still be 40 degrees but the angle θ would change from 35 degrees to a value greater than 35 degrees.

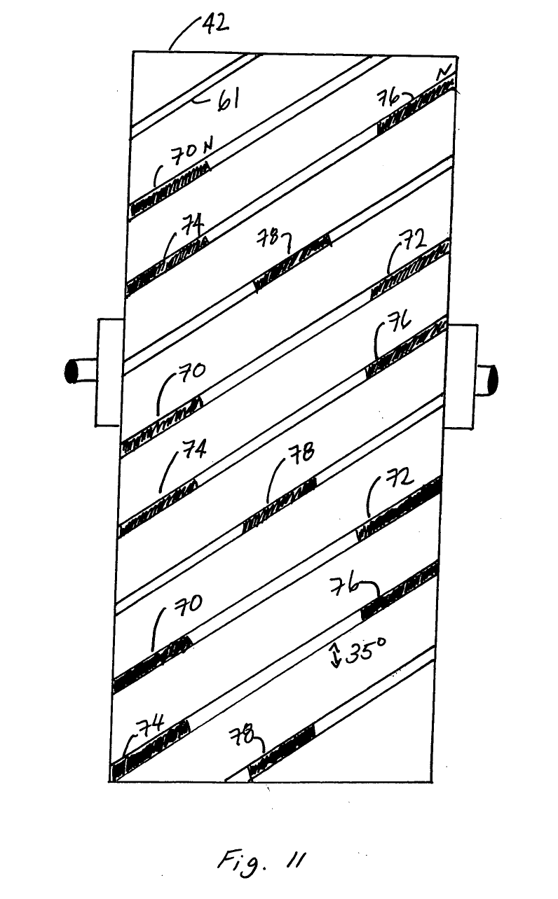

Referring to FIG. 10 a schematic representation of the grooves in wheel 34 on the right side is shown. The representation is equivalent to cutting the surface of the wheel 34 and then laying it out flat. It can be seen that there are a total of 9 grooves that dip down from left to right at an angle of 35 degrees. The diameter across the wheels measured from the bottom of the grooves 60 is 9 inches. Consequently, the arc length from the bottom of one groove to the bottom of an adjacent groove is π inches(i.e., 3.14 inches). Bar magnets are fitted into the grooves 60. In two adjacent grooves 60, bar magnets 60, 62 and 64, 68 are fitted into the opposite ends of each groove 60. In the next groove a single bar magnet 66 is fitted into the center of the groove. Finally, in the remaining grooves the same pattern is repeated. The north pole of each bar magnet faces outwardly towards the opening into each groove 61.

Referring to FIG. 11, a schematic representation of the grooves in wheel 42 is shown. In this case the pattern of the placement of permanent magnets is the same as for FIG. 10 except that the grooves 61 are inclined upwardly from left to right rather than down as in FIG. 10. In this case permanent magnets 70, 72 and 74, 76 are inserted into the opposite ends of two adjacent grooves. Permanent magnet 78 is then inserted into the center of the next groove 61 and the pattern is repeated for each adjacent set of three grooves 61. Again the north pole of each permanent magnet faces outwardly.

The orientation of the poles of the permanent magnets on the cowlings is such that the north pole is glued to the cowling. The permanent magnets on the cowlings will repel the bar magnets positioned in the grooves. The action of the two spaced apart permanent magnets 42, 44 and 50, 52 on cowlings 20 and 21, respectively, and permanent magnets 46, 48 and 54, 56 on cowlings 22 and 23, respectively, on the permanent magnets in grooves 60 and 61 result in rotation of each of wheels 34 and 42.

Adjustment of the spacing between the cowlings 20 and 21 and 22 and 23 by means of cranks 40 and 38, respectively, adjusts the strength of the interaction of the fields of the permanent magnets and hence the torque on the wheels 34 and 42.

Shaft 12 could be coupled to the armature of a generator and used to generate electricity. Alternatively, the magnetic motor could itself drive a vehicle transmission directly. There are many different applications for this motor. By using very strong permanent magnets useful power can be generated.

It is possible to vary the dimensions of the wheel 14, and 16, which has an outer diameter of 10 inches and a width of 5 inches as long as a disk wheel template with markings at 20 degrees and a change over the groove length of 40 degrees is employed. The motor can operate with the shaft 12 vertical or horizontal. While aluminum is a suitable material for the motor, the use of a hard plastic also possible.

By using two wheels rather than just one, any dead spots in one wheel will be compensated for by the other wheel.

Accordingly while this invention has been described with reference to illustrative embodiments, this description is not intended to be construed in a limiting sense. Various modifications of the illustrative embodiment will be apparent to those skilled in the art upon reference to this description. It is therefore contemplated that appended claims will cover any such modifications or embodiments as fall within the scope of the invention.

What is claimed is:

1. A magnetic motor, comprising:
(a) a frame;
(b) a shaft coupled to said frame;
(c) a pair of non-magnetic wheels mounted on said shaft, wherein for each wheel one of said shaft and said each wheel is rotatable and said each wheel has a plurality of equally spaced apart grooves running over a cylindrical surface of said wheel from a first side to a second side of said wheel with a radial separation of a start of said groove on said first side to an end of said groove on said second side being 40 degrees and an orientation of said grooves on said pair of wheels being opposite to one another; and
(d) a pair of non-magnetic cowlings, each having a semi-circular surface facing said wheel of slightly larger diameter than said wheel;
(e) a pair of spaced apart permanent magnets affixed to an outside surface of each of said pair of cowlings oriented with a north pole of each of said permanent magnets facing a corresponding cowling, said permanent magnets on said front cowling being ⅛^{th} and ⅝^{th} up, respectively, from a bottom thereof and said permanent magnets on said rear cowling being ⅜ths and 15/16^{th} up from a bottom thereof; and
(f) a plurality of permanent magnets placed in said grooves in a pattern with two permanent magnets placed on opposite sides of each of two adjacent grooves and one placed at the center of a third groove adjacent to said two adjacent grooves and placing permanent magnets for subsequent grooves with the same pattern, a north pole of each of said permanent magnets facing outwardly.

2. The magnetic motor according to claim 1, wherein the number of grooves on each wheel is an integral multiple of 9.

3. The magnetic motor according to claim 1, wherein a pair of said cowlings associated with one of said wheels are adjustably movable towards or away from said one wheel so as to adjust the spacing between said one wheel and each cowling of said pair of cowlings.

4. The magnetic motor according to claim 1, wherein said grooves on a left side wheel of said pair of wheels are inclined upwardly from left to right at an acute angle. and those on a right side wheel of said pair of wheels are inclined downwardly from left to right. at an acute angle.

5. The magnetic motor according to claim 1, wherein said cowlings each have holes to threadedly receive ferromagnetic bolts to assist in eliminating dead spots.
